(19) United States
(12) Patent Application Publication
(10) Pub. No.: US 2021/0364717 A1
(43) Pub. Date: Nov. 25, 2021

(54) Assembly of 2-Dimensional Matrix of Optical Transmitter or Receiver Based On Wet Etched Silicon Interposer

(71) Applicant: Technische Universiteit Eindhoven, Eindhoven (NL)

(72) Inventors: Chenhui Li, Eindhoven (NL); Oded Raz, Eindhoven (NL); Ripalta Stabile, Eindhoven (NL)

(21) Appl. No.: 16/642,137

(22) PCT Filed: Sep. 7, 2018
(86) PCT No.: PCT/EP2018/074234

§ 371 Date: Feb. 26, 2020

Related U.S. Application Data
(60) Provisional application No. 62/555,845, filed on Sep. 8, 2017.

(51) Int. Cl. G02B 6/43; G02B 6/42; G02B 6/38

(52) U.S. Cl. CPC G02B 6/43; G02B 6/4292; G02B 6/4269; G02B 6/4246; G02B 6/3853

(57) ABSTRACT

An optical interconnect includes CMOS drivers/receivers, vertical cavity surface emitting lasers (VCSEL) or photo detectors (PD), a silicon interposer having a electrical interface connected to a pattern of wet etched square-box shape optical through silicon vias (OTSV), the CMOS drivers/receivers are connected to the electrical interface, the VCSEL/PDs are connected to the end of the electrical interface, each input/output signal of the VCSEL/PDs are aligned with the pattern of OTSVs, an optical interface (01) connected to a second side of the interposer, the optical interface is aligned with the OTSVs, the optical interface planar surface is on the silicon interposer second side and a pattern lenses opposite the planar surface and match the OTSVs, and a lensed ferrule having a pattern of lenses arranged to match the pattern of optical interface lenses, the ferrule connects with optical fiber arrays to directly connect to all the drivers or receivers.

### FIELD OF THE INVENTION

The current invention relates generally to electro-optic transmitters. More specifically, the invention relates to 2-D optical assembly on a patterned silicon interposer for high data rate transceivers.

### BACKGROUND OF THE INVENTION

To meet the demand of data communication, data centers are scaling up, and an increasing number of parallel optical interconnects are needed. Electro-optical transceivers are essential parts in these networks, allowing for low loss data transport and next to fast electronic packet switching.

These transceivers should preferably work at high data rates and be fabricated using low-cost manufacture and assemble processes. On the other hand, as the performance of processors improve, the number of off-chip inputs/outputs, provided by arrays package, reaches their limit. Employing the surface area of processors for optical interconnects can be a solution, which requires small form factor transceivers based on 2-D arrays of emitters/detectors to be stacked on the top of the functional IC to achieve higher density of inputs/outputs ports.

Transceivers, based on vertical-cavity surface-emitting lasers (VCSELs), working at 850 nm, have become the most prevalent short-reach optical interconnect solutions. Further, scaling optical interconnects in density through making 2-D matrix of emitters and detectors is difficult, due to the high cost of 2-D optical chips and associated packaging issues. Previously, 2-D optical array co-packaged on an active CMOS driver/router chip has been developed; however, the whole packaged scheme required fully dedicated 2-D optoelectronic and application-specified integrated circuit (ASIC) chips designs. The optoelectronics were assembled on the active CMOS chip, which inevitably consumes valuable silicon area and increases the associated costs. A special optical fiber-bundle assembly was also needed for the full package demonstration. A back-end-of-line processed silicon interposer-based transceiver was also demonstrated; however, the process included numerous electrical through silicon vias (TSVs) and optical holes, delaying its introduction into high volume manufacturing. In addition, proprietary offset optical arrays and CMOS ICs were used to realize the connection between them.

What is needed is a 2-D transmitter/receiver having higher bandwidth density.

### SUMMARY OF THE INVENTION

To address the needs in the art, an optical interconnect is provided that includes a plurality of CMOS drivers or a plurality of CMOS receivers, a plurality of vertical cavity surface emitting lasers (VCSEL) dies or a plurality of photo detectors (PD) dies, a silicon interposer, where a first side of the silicon interposer comprises an electrical interface connected to a pattern of wet etched optical through silicon vias (OTSV), where the plurality of CMOS drivers or the plurality of the CMOS receivers are connected to a first end of the electrical interface, where the plurality of VCSEL dies or the plurality of PDs are connected to a second end of the electrical interface, where each input/output signal of the plurality of VCSEL dies or the plurality of PDs are aligned with the pattern of OTSVs, an optical interface (OI) connected to a second side of the silicon interposer, where the optical interface is aligned with the pattern of wet etched OTSVs, where the optical interface comprises a planar surface on the silicon interposer second side and a pattern of optical interface lenses opposite the planar surface, where the pattern of optical interface lenses matches the pattern of wet etched OTSVs, and a lensed ferrule having a first side and a second side, where the lensed ferrule first side includes a pattern of ferrule lenses arranged to match the pattern of optical interface lenses, where the lensed ferrule second side connects with optical fiber arrays, where the optical fiber arrays are directly connect to all the plurality of CMOS drivers or the plurality of CMOS receivers.

According to one aspect of the invention, the OTSVs have a substantially square-box shape.

In one aspect of the invention, the plurality of CMOS drivers or the plurality of CMOS receivers, and the plurality of VCSEL dies or the plurality of PD dies are flip chip bonded to the silicon interposer.

According to another aspect of the invention, the silicon interposer includes 2-D multi-channel optical outputs with a pitch of 250 μm in both matrix directions, where the number and arrangement of the 2-D multi-channel optical outputs match the number and arrangement of the VCSEL dies or the plurality of PDs.

In a further aspect of the invention, the OI includes a single OI attached at the second side of the silicon interposer, where the OI is configured to couple the I/O signal from the plurality of VCSEL dies or the plurality of PDs through the pattern of OTSVs into fiber ribbons.

In another aspect of the invention, the silicon interposer second side further includes at least one heat sink connected there to.

In yet another aspect of the invention, each CMOS driver includes a 4-channel CMOS driver, or a 12-channel CMOS driver.

According to one aspect of the invention, each CMOS receiver includes a 4-channel CMOS receiver, or a 12-channel CMOS receiver.

In another aspect, the invention is process of fabricating the interposer using the wet etch method to improve the shape of the OTSVs, and flip-chip bonding of dies for assembly, to better enable higher bandwidth density.

### BRIEF DESCRIPTION OF THE DRAWINGS

FIG. 1 shows a scheme drawing of the 2-D optical assembly on a patterned silicon interposer (cross section), including the OI, heatsink, four optics arrays, and their CMOS drivers, according to one embodiment of the invention.

FIG. 2 shows a schematic of the 2-D layout on the fabricated interposer having silicon optical vias with 250-μm pitch in both the x- and y-directions, according to one embodiment of the invention.

FIG. 3 shows light coupling schematic for the machined ferrule, according to one embodiment of the invention.

FIGS. 4A-4B show alignment tolerance measurement results. Effect of the distance between VCSEL and cut plane on coupling power loss (4A). Effect of x- and y-offsets from best coupling point (z=150 μm) on coupling power loss (4B), according to one embodiment of the invention.

FIGS. 5A-5B show transmission S(4,1), S(6,5) and reflection S(1,1), S(5,5) parameters of path 0 (long trace) and path 11 (short trace) at the frequency range from 0 to 50 GHz (5A). Electrical crosstalk between two long traces, NEXT S(1,2) and FEXT S(1,3) (5B), according to one embodiment of the invention.

FIG. 6 shows a SEM image of CPW connections and OTSV s for 48 channels of VCSEL arrays. Inset: zoomed-in SEM image of channels at corner shows the CPW, OTSV, and Au bump, according to one embodiment of the invention.

FIG. 7 shows a camera image under microscope, taken from the backside of silicon interposer through optical vias, after flip-chip bonding of VCSELs, according to one embodiment of the invention.

FIG. 8 shows a camera image under microscope of fully assembled 48-channel transmitter submodule. Each quadrant of VCSELs is connected with one CMOS driver, and the middle channels of VCSEL array are connected with longest traces, according to one embodiment of the invention.

FIG. 9 shows a camera image of the side view of the assembled transmitter submodule. The attached OI is connected with a ferrule and the fiber ribbons, according to one embodiment of the invention.

FIGS. 10A-10B show eye patterns of all 48 channels, working at 15 Gb/s, 231-1 PRBS (10A), and an enlarged view of a single eye pattern of one of the 48 channels (10B), according to one embodiment of the invention.

### DETAILED DESCRIPTION

Disclosed herein is an optical interconnect device having 4 pairs of commercial 12-channel electronic and photonic dies assembled on a patterned wet etched silicon interposer for a terabit/s class optical interconnect. In one embodiment, the optical dies are flip-chip bonded to forma 4°-12 optical matrix with 250-μm pitch in both the x- and y-directions. A single compact optical connector, which is a derivative of a PRIZM MT ferrule, is employed to enable a single and direct connection of four fiber ribbons to all 48 channels. The alignment tolerance of the suggested optical connector is tested, and the best-case loss is 1.0 dB. The electrical interface, for the connection of CMOS ICs and vertical cavity surface-emitting laser (VCSEL) dies, is designed and patterned on the silicon interposer. The process and assembly are also described herein. In performance testing, clear eye patterns for all the 48 channels are captured at 15 Gb/s with a pseudorandom bit stream 231-1 patterns. The bit error rate curves of all the channels are recorded at 10 Gb/s and show a receiver sensitivity spread of less than 2.1 dB across all 48 channels at 10-12 level. In addition, crosstalk effects are also characterized, showing a negligible power penalty of less than 0.2 dB. The fully assembled module can offer for the first time 0.72 Tb/s optical data output, within an area of 1.32 cm² by using low cost processes and commercially available dies.

According to one embodiment, 2-D arrays of emitters/detectors are provided may make use of 1-D array dies that are then assembled through a single-side designed electrical interface. In this embodiment, impedance matched traces are designed for 2-D arrays connections to enable a simple 2-D optical connector.

To take advantage of the low cost processed silicon interposer and of available higher resolution lithography, the current invention provides a new 2.5-D scheme for connecting 2-D optoelectronics and their CMOS IC parts. Provided herein, the 2.5-D schematic is exploited, and for the first time, a 2-D 48-channel transmitter is fully assembled, offering 0.72 Tb/s optical data output within an area of 1.32 cm². The electrical interface performance is improved by additional straightforward surface treatment processes.

In addition, the optical interface (OI) insertion losses are reduced by setting the optimal distance between VCSELs and OI. In one example, a single direct optical connection with fiber ribbons to all 48 channels, with optical losses as low as 1.0 dB, is demonstrated.

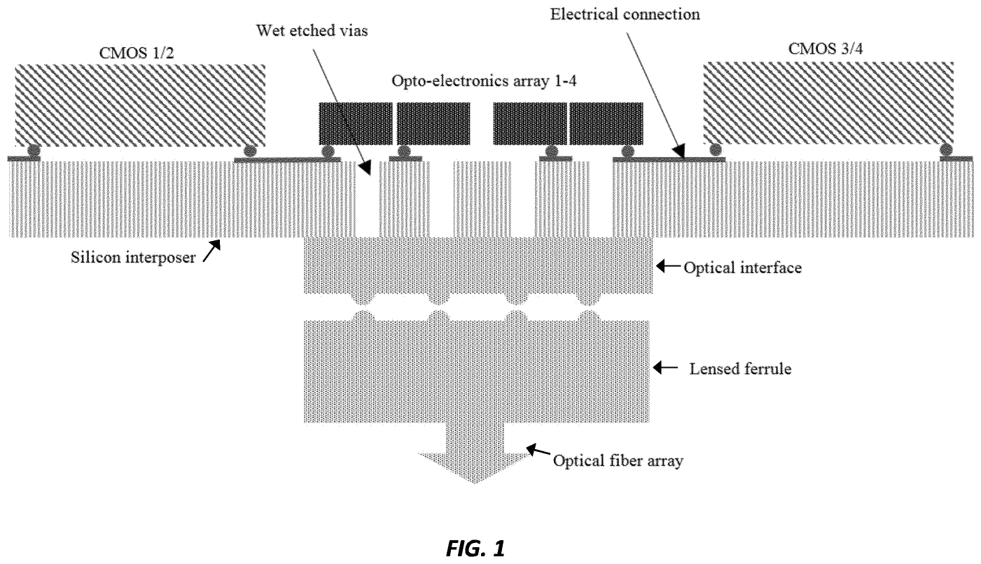

A schematic drawing of one embodiment of the assembly is shown in FIG. 1. The passive silicon interposer is patterned to provide the metal traces and optical vias, used for the full assembly of the electronic and optoelectronic dies. In this disclosure, arrays of four dies are described, however it is understood that the arrays can be four dies or more. In the current embodiment, four 12-channel VCSEL arrays are aligned and flip-chip bonded side by side in the center of the silicon interposer to create 2-D 48-channel optical outputs with a pitch of 250 μm in both matrix directions. A single OI is attached at the opposite side of silicon, to couple the light from the 48 VCSEL channels through OTSVs into standard fiber ribbons.

The suggested position of the heatsink at the bottom of the schematic drawing is made possible; thanks to the fact that silicon is an excellent thermal conductor and the heat can be easily transferred to the heatsink regardless of the side on which it is assembled. The total area of the backside is 132 mm², and there is a total available convective cooling area of 100 mm². With a heat transfer coefficient of 5000 W/K·m² on the cooling area, the whole module is expected to stay below 40° C., while working at room temperature (22° C.).

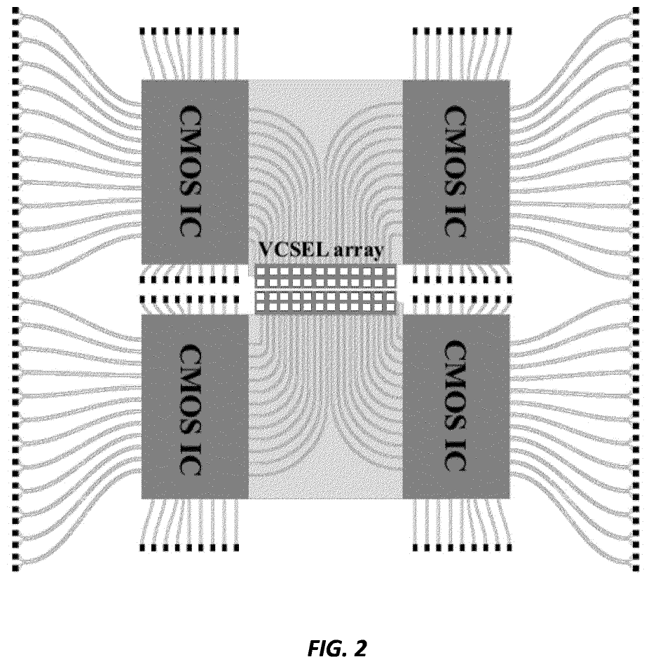

The placement of the dies and connection details are shown in FIG. 2. Four 12-channel CMOS drivers are placed at the four corners of the silicon interposer, and each driver is connected to one quarter of the optical matrix through coplanar waveguides (CPWs). This design choice implies the co-presence of longer and shorter CPWs for the same driver connections. Coupled traces, with 100-impedance matching, are routed to the edges of the silicon interposer with a pitch of 250 μm. The size of the assembled transmitter module is 11 mm×12 mm and thickness is 1.2 mm. This small form factor transmitter means that the same module can be used for different applications (pluggable, onboard, on-chip, and so on). The assembled module can also be surface mounted on a print circuit board (PCB) with recessed area, because all the connections are routed to 1-D pad arrays with a pitch of standard 250 μm. The electrical connections from PCB can be designed as standard interfaces, for example, on board optics, for the connections with ASIC.

To realize a low-cost optical access by direct fiber attachment, the light coupling and alignment mechanism is employed between two PRIZM MT ferrules, which offer collimated beams and are used for high counts multimode fibers connections. The lens array and the self-aligning post and hole are removed at the head of one ferrule, by machining one ferrule, or fabrication without one ferrule. In this way, the optics and the alignment features of the original ferrule are retained, and a robust OI is realized, which will connect to its mated ferrule. In addition, the lensed ferrule requires a force of only 3N to maintain contact at the lens mating plane, which is much lower than the normal ferrule and can be easily achieved. Therefore, no stress or reliability issues result of connector mating. The complexity and space of the ferrule housing can be eliminated accordingly for a small form factor package. This is a low-cost method for vertically coupling fiber ribbons to arrays of VCSEL/photodiode, benefitting from expanded light beams created by the lenses at the end face of the connectors. Based on the PRIZM MT ferrule design, this high-potential platform will support up to 16-fiber ribbons in 4 rows, for fibers counts as high as 64, according to this embodiment.

Apart from cutting off part of the ferrule, the total thickness of the OI is further micromachine to accommodate the silicon interposer and get the lowest coupling losses with the VCSELs, since the ferrules and lenses are originally designed for light coupling between multimode fibers.

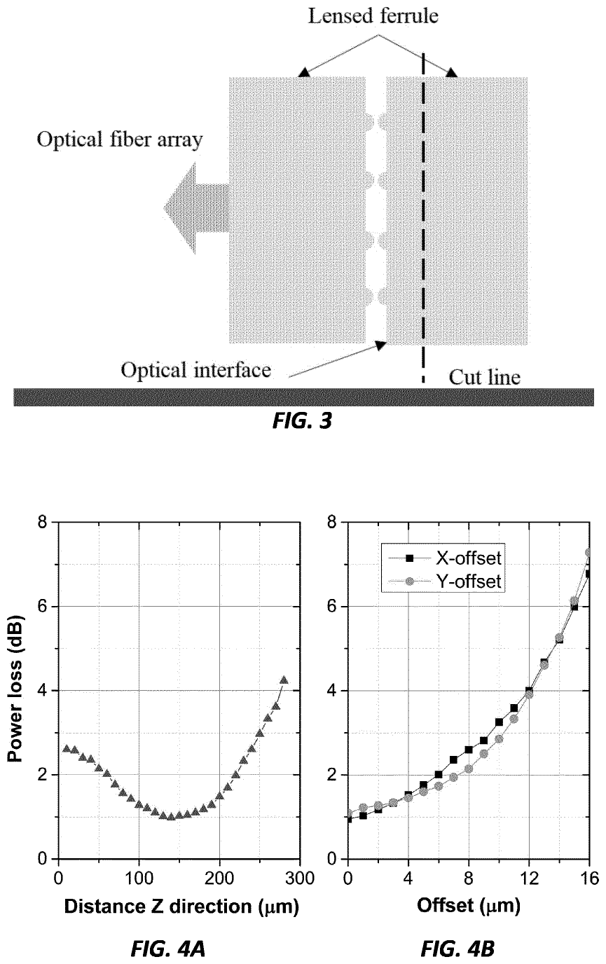

After machining 150 μm of the OI, the light coupling tolerance test is first performed on a flip-chip bonder, which provides a positioning accuracy of within 1 μm in the x- and y-directions and 10 μm in the z-direction. The scheme and the setup are shown in FIG. 3. The fabricated OI together with the ferrule is clamped on the arm of the flip-chip bonder and connected with fiber ribbons. A VCSEL is used with a 25° beam divergence and 8.5-μm aperture diameter. The lens of OI is aligned with the aperture of the VCSEL, and the optical output is tested by one of the break-out fibers, changing the distance in the z-direction with a 10 μm step. In addition, at the best coupling z-position, the light loss was also tested by changing x- and y-offsets, with the step of 1 μm, to measure the alignment tolerances.

The testing results are shown in FIGS. 4A-4B. The minimum coupling loss for the OI is 1.0 dB, which corresponds to a distance of this machined OI of 150 μm. There is around 0.7 dB loss in the coupled ferrules, which is the main reason for power loss. Since the ferrule is originally designed for fiber connections, beam divergence could be another reason for the optical loss. Besides, there are 1.5 dB displacement tolerances of ±50 μm in the z-direction, while for the x- and y-directions a 1.5 dB displacement tolerance of ±5 μm is measured. In the scheme shown in FIG. 1, the gap between OI and VCSEL is set by the thickness of the wafer, which should be thinned to be 150 μm to achieve optimal light coupling.

During assembly, four VCSEL arrays are passively aligned according to the corresponding OTSVs, one by one. The OI is aligned to apertures of VCSELs to avoid building up alignment error. A 1.5-dB displacement tolerance can be guaranteed, for a misalignment of ±5 μm. In addition, since the alignment features of the ferrules are kept, the fan-out fibers can be assembled without any further alignment.

As shown in the packaging embodiment, to replace wire bonding, the optical and electrical dies are flip-chipped on the silicon interposer. Therefore, all of the electrical connections are designed with impedance matched connections and fabricated through standard lithography and electroplating processes on one side of the silicon interposer. Two kinds of transmission lines (TMLs) are used in connections, the 100-differential TML for the digital signal metal lines (toward the CMOS inputs) and the single-ended TML for analog signal metal lines (from CMOS to optics).

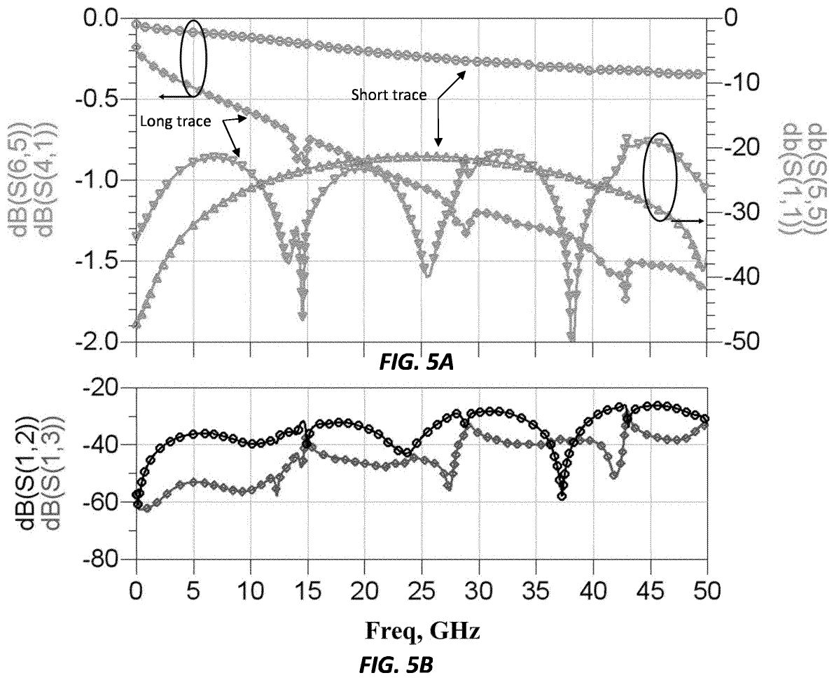

Further disclosed herein, the single-ended (analog) TMLs are also designed by using the Keysight Advanced Design System (ADS) software. The CPW is designed on high-resistivity silicon substrate (2000 cm), with a dielectric layer of SiNx, 200 nm thick. The electrical connections between driver and VCSEL are designed as 50-CPWs, with 25 μm width of signal trace and 11 μm gap, matching the expected series resistance of the VCSELs. The entire design of driver 3, shown in FIG. 2, is developed by maintaining impedance matching in ADS, calculating simultaneously six ports on both ends of the traces (including the two longest traces and one shortest trace). Transmission parameters of the long (5 mm, path 0 and short (0.9 mm, path 11) traces are simulated. As shown in FIG. 5A, the transmission loss is 1.7 dB [S(4,1)] and 0.4 dB [S(6,5)] at 50 GHz, respectively, for paths 0 and 11, and the reflection [S(1,1) and S(5,5)] is below −20 dB. In addition, the channel crosstalk is also simulated: both near-end crosstalk (NEXT) and far-end crosstalk (FEXT) between two long traces are below −25 dB, shown in FIG. 5B.

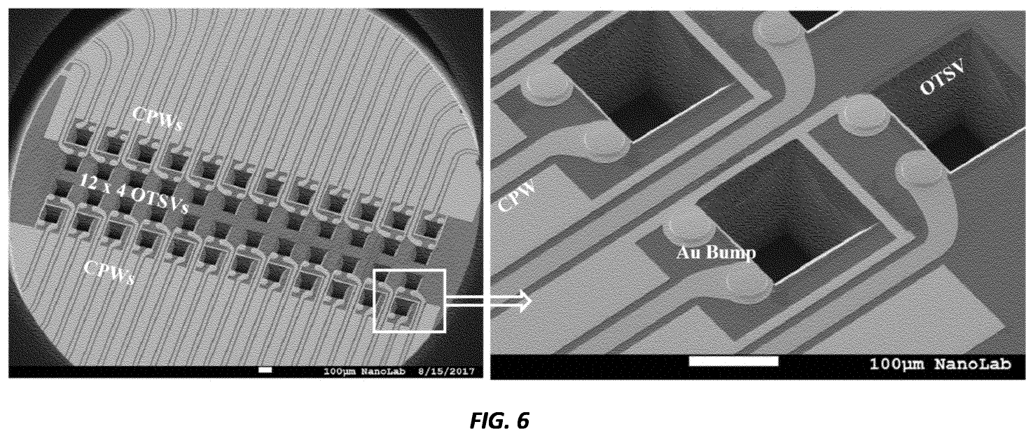

The fabrication process, using the standard CMOS technology, includes four steps of lithography. According to the coupling testing of the machined OI, the distance between the VCSEL and OI needs to be optimized. Therefore, the cleaved 1-inch silicon sample with a thickness of 210 μm is further thinned down to 180 μm in potassium hydroxide (KOH) solution at 80.0° C. Further thinning of the substrate is not done to avoid possible breaking of the wafer during the process. Additional oxygen plasma treatment and buffered hydrofluoric dip are used to clean the surface. About 200-nm-thick SiNx mask is then deposited. Before performing the lithography steps to define the metal traces and bumps, a seed layer is sputtered. Following two steps of electroplating, the OTSVs are made by double-side anisotropic silicon wet etching in the same KOH solution, and vertically side walls are formed by controlling etching time. The SEM image in FIG. 6 shows the CPWs for the electrical connections and the OTSVs for 48-channel VCSEL, after removing the seed layer. All of the traces are well defined on one layer with a single lithography step, without passivation: this further lowers down the process costs associated with larger wafer processing. The inset shows gold bumps and the details of OTSVs, with vertically etched side wall.

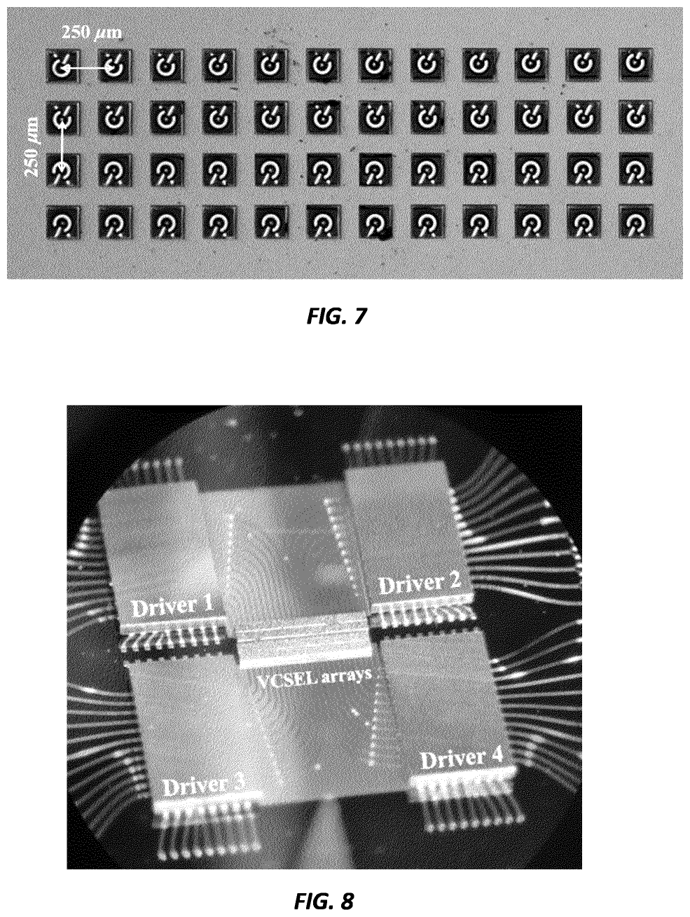

After the fabricating process is complete, the silicon interposer is cleaved out for further assembly. Optics and electronic dies are flip-chip bonded on the die bonder. After a heat reflow (280° C.), the gold pads on the VCSEL and the plated bumps on silicon interposer are connected. Four VCSEL arrays are aligned one by one based on the OTSVs and optical apertures of VCSEL. A slight mismatch took place, during assembly, between arrays 1 and 2 and arrays 3 and 4. These two array groups are bonded back to back. This is due to a small offset of the OTSV with respect to the VCSELs apertures when rotating the VCSEL arrays. A microscope photo is taken from the back side of the silicon interposer, showing the 2-D apertures of 48 VCSELs in FIG. 7. After that, four VCSEL drivers are also reflowed (225° C.) on the same die bonder. The final step of the assembly is the OI attachment on the opposite side of silicon interposer. Similar with the light coupling test, the alignment is performed between the lens of OI and apertures of VCSELs. Since there is an offset between two opposite VCSELs groups, lenses of OI are aligned with the 24 apertures of one group to get the best light coupling value. As a result, the coupling results for the other group are impacted due to the slight misalignment. The OI is aligned and mounted at the backside of silicon interposer by epoxy, with 2-h curing at 65° C. A camera image from the top side of silicon carrier under microscope shows the fully assembled transmitter (FIG. 8).

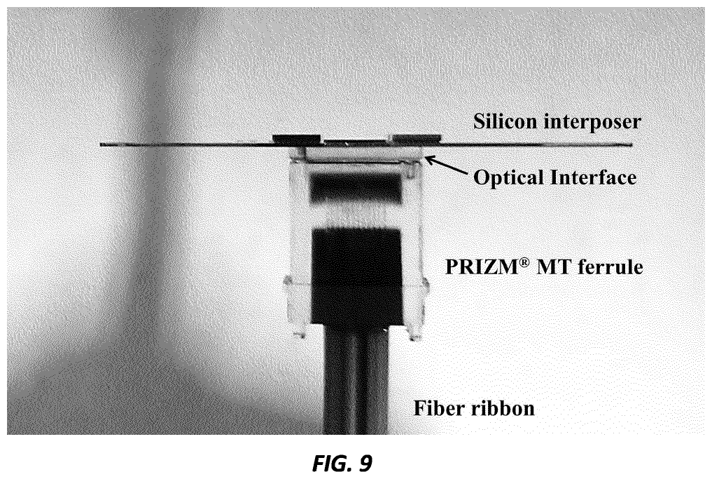

As shown in FIG. 9, through the guide post and hole, a standard 48-channel PRIZM MT ferrule is connected with the fixed OI on the opposite side of silicon interposer with a clamping tool. The 48 separate channels are made accessible using an multi-fiber push on to 48 break-up LC fibers.

The assembled 48-channel transmitter is completely characterized on a probe station. Power and control signals are provided to the pads on the top surface of silicon interposer through multiprobes. The differential probes are used for the high-speed electrical signal inputs. The commercial SFP+ module and QSFP28 are used as photodetectors for the 10 and 15 Gb/s characterization.

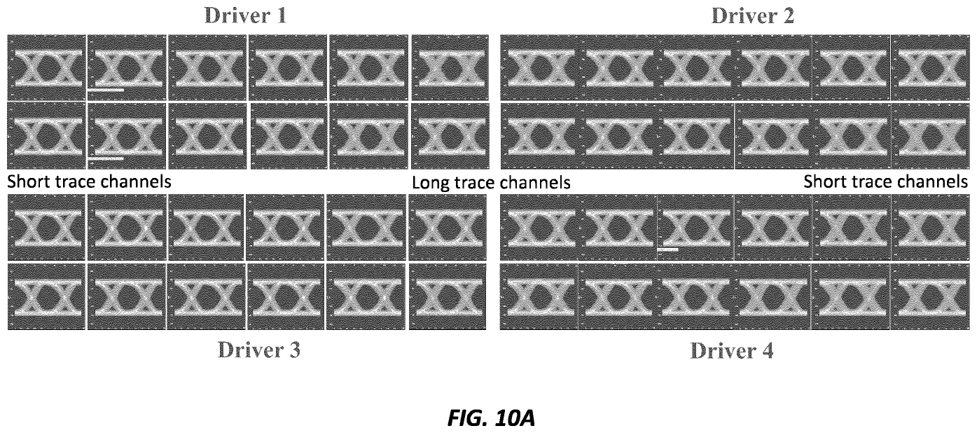

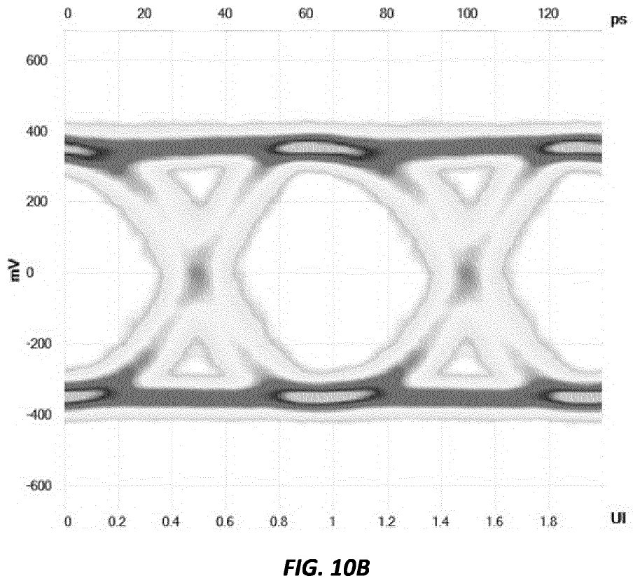

First, eye diagrams are measured at 15 Gb/s, which is 50% higher than the chipset specification. A non-return to zero with a 231-1 pseudorandom bit stream (PRBS) is fed by multiple differential RF probes (signal-signal) through fan-out pads on the silicon interposer of each channel. The converted optical signal is detected by the QSFP28 module through the breakup LC fiber. The eye patterns of the electrical output from the QSFP28 are captured by an oscilloscope. All 48 channels are separately driven by the four drivers. Uniform and clear eye patterns are obtained. FIG. 10A presents the eye patterns from all channels, shown with the same position of the bonded VCSEL channels and the indication of different length of CPWs. Bit error rate (BER) is tested at 10 Gb/s with 231-1 PRBS patterns. The QSFP28 is replaced by the SFP+, and the converted electrical signal is characterized by an error detector. FIG. 10B shows eye patterns of one of 48 channels at working at 15 Gbps.

All of the 48 channels have been tested, grouped into the four drivers. The four groups of 12 receiver sensitivity curves were generated, and each group includes the shortest and the longest trace, with the spread of power penalty of 1.9, 1.8, 1.5, and 1.7 dB for each group at 10-12 level. The channels with longer traces are under performing, which are mainly due to the higher loss in long channels. This is validated by using a vector network analyzer to test the actual transmission S(2,1) and reflection S(1,1) parameters of the traces on the silicon interposer, fabricated in the same batch. From the testing results, there is a higher loss, while reflection is low in the entire band (−20 dB), comparing with simulation results in FIG. 5. These higher measured losses are mainly due to the thin gold traces. In one embodiment, a thicker layer of gold is plated to improve the ohmic loss. Moreover, this loss spread is a consequence of the design choice to place the drivers at the four corners of the silicon die. Therefore, only by rotating the CMOS drivers, the length of CPWs can be balanced to minimize this variation.

The effect of channel crosstalk (including electrical and optical crosstalk) is also characterized by testing the penalty at the receiver sensitivity curves.

First, the optical power leaking into an adjacent channel to the active one is measured to be below −50 dBm, which indicates nearly no power leakage to neighbor channels. After that, the three pairs of differential signals are fed into three adjacent channels of driver 3, channels 1, 2, and 3, which represent the longest traces, shown in FIG. 2. In one embodiment, channel 2 is routed between 1 and 3, and the optical output of channel 3 is closer to that of channels 1 and 2 in the x- and y-directions. Therefore, the BER curves of channel 2 (worst effected electrical channel) and channel 3 (worst effected optical channel) were generated, which showed together with the curves related to the case all three channels are working at same time. Very limited effect of crosstalk is found: less than 0.2-dB power penalty is measured.

During testing, the highest output optical power of all 48 channels is recorded, and the power loss of each channel is calculated based on an absolute output value of 1.0 dBm.

The output power of the best coupled channel is −0.2 dBm, indicating the lowest possible total coupling loss of 1.2 dB. The additional 0.2-dB loss, comparing with the coupling test results, is mainly due to a thicker interposer used. Three worst channels, channel 1 of arrays 1, 2, and 3, show a large additional loss, 6.4, 7.7, and 7.7 dB, respectively. This is due to the spread of the epoxy during mounting. Small trenches can be etched during the etching of via to guide the epoxy filling.

In addition, because there is a shift of array 1 and array 2, comparing with the other two arrays, this causes an additional 1.5-dB loss, indicating around 8-μm total misalignment (in FIG. 4).

The average power loss in the alignment between VCSELs and OI is calculated to be 2.4 dB, excluding the three worst channels. Furthermore, the standard deviation of each array is calculated to be 0.36, 0.27, 0.35, and 0.44 dB for arrays 1-4, respectively. In addition, the deviation of coupling losses can be reduced by aligning of OI to the OTSVs, which is a standard matrix indicating the average positions for all the channels.

Provided herein is a novel approach for the VCSEL-based high-density 2-D 48-channel optical transmitter packaging. A low-cost wet etched silicon interposer is designed and fabricated for components assembly. The highly integrated optical transmitter module is packaged with only commercial components. Besides, a low-cost OI with up to 64 lanes is designed based on commercially available ferrules. The coupling tolerance is tested, showing the loss can be as low as 1.0 dB and below 1.5 dB within the range of 100 μm in the z-direction, and 3 dB within 10 μm in the x- and y-directions. The 250-μm pitch 2-D optical transmitter is easily coupled with standard fiber ribbons through this machined OI.

All 48 channels of transmitters have been tested. Uniform and clear eye patterns for all the channels are captured at 15 Gb/s with PRBS 231-1 pattern. The BER curves and crosstalk effect are also measured. The results show that the long traces channel perform less, with around 1 dB additional power penalty. The victim channels of electrical and optical crosstalk are tested, respectively, show the neglect power penalty (less than 0.2 dB). The transmitter offers up to 0.72 Tb/s data rate for a total density of 5.45 Gb/s/mm², indicating that this packaging approach is a promising solution for terabits class module in the next generation optical interconnection links.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. For example, better placement of CMOS ICs could deliver a more balanced and shorter length of CPWs, together with shorter differential traces, within 1 cm². A smaller form factor can also be beneficial as it may enhance the mechanical strength of the assembled module. If 25 Gb/s chipsets are used, higher data rate of up to 1.2 Tb/s is possible within the same area. In addition, the maximum lane counts are 64, which means more channels can be integrated on this platform to meet the requirements of higher data rate. All such variations are considered to be within the scope and spirit of the present invention as defined by the following claims and their legal equivalents.

What is claimed:

1) An optical interconnect, comprising:
a) a plurality of CMOS drivers or a plurality of CMOS receivers;
b) a plurality of vertical cavity surface emitting lasers (VCSEL) dies or a plurality of photo detectors (PD) dies;
c) a silicon interposer, wherein a first side of said silicon interposer comprises an electrical interface connected to a pattern of wet etched optical through silicon vias (OTSV), wherein said plurality of CMOS drivers or said plurality of said CMOS receivers are connected to a first end of said electrical interface, wherein said plurality of VCSEL dies or said plurality of PDs are connected to a second end of said electrical interface, wherein each input/output signal of said plurality of VCSEL dies or said plurality of PDs are aligned with said pattern of OTSVs;
d) an optical interface (OI) connected to a second side of said silicon interposer, wherein said OI is aligned with said pattern of wet etched OTSVs, wherein said OI comprises a planar surface on said silicon interposer second side and a pattern of optical interface lenses opposite said planar surface, wherein said pattern of OI lenses matches said pattern of wet etched OTSVs; and
e) a lensed ferrule having a first side and a second side, wherein said lensed ferrule first side comprising a pattern of ferrule lenses arranged to match said pattern of OI lenses, wherein said lensed ferrule second side connects with optical fiber arrays, wherein said optical fiber arrays are directly connect to all said plurality of CMOS drivers or said plurality of CMOS receivers.

2) The optical interconnect of claim 1, wherein said OTSVs comprise a substantially square-box shape.

3) The optical interconnect of claim 1, wherein said plurality of CMOS drivers or said plurality of CMOS receivers, and said plurality of VCSEL dies or said plurality of PD dies are flip chip bonded to said silicon interposer.

4) The optical interconnect of claim 1, wherein said silicon interposer comprises 2-D multi-channel optical outputs with a pitch of 250 μm in both matrix directions, wherein the number and arrangement of said 2-D multi-channel optical outputs match the number and arrangement of said VCSEL dies or said plurality of PDs.

5) The optical interconnect of claim 1, wherein said OI comprises a single OI attached at said second side of said silicon interposer, wherein said OI is configured to couple said I/O signal from said plurality of VCSEL dies or said plurality of PDs through said pattern of OTSVs into fiber ribbons.

6) The optical interconnect of claim 1, wherein said silicon interposer second side further comprises at least one heat sink connected there to.

7) The optical interconnect of claim 1, wherein each said CMOS driver comprises a 4-channel CMOS driver, or a 12-channel CMOS driver.

8) The optical interconnect of claim 6, wherein each said CMOS driver further comprises a transimpedance amplifier (TIA).

9) The optical interconnect of claim 1, wherein each said CMOS receivers comprises a 4-channel CMOS receiver, or a 12-channel CMOS receiver.
